(19) United States
(12) Patent Application Publication
(10) Pub. No.: US 2025/0280998 A1
(43) Pub. Date: Sep. 11, 2025

(54) HAND-HELD GRINDER

(71) Applicant: NINGBO CHEFSHERE KITCHEN TECHNOLOGY CO.,LTD., Ningbo (CN)

(72) Inventor: Guoping ZHANG, Ningbo (CN)

(73) Assignee: NINGBO CHEFSHERE KITCHEN TECHNOLOGY CO.,LTD., Ningbo (CN)

(21) Appl. No.: 19/073,078

(22) Filed: Mar. 7, 2025

(30) Foreign Application Priority Data
Mar. 7, 2024 (CN) 202420440071.2
Sep. 30, 2024 (CN) 202422397994.7

(51) Int. Cl. A47J 42/08; A47J 42/04

(52) U.S. Cl. CPC A47J 42/08; A47J 42/04

(57) ABSTRACT

A hand-held grinder includes a cartridge with an inner cavity, where an adjusting ring is provided on the cartridge; the adjusting ring is sleeved on the cartridge; the adjusting ring is threadedly connected to the cartridge; a mounting sleeve and a grinding assembly are provided in the cartridge; the grinding assembly includes an outer grinding head and an inner grinding head; the outer grinding head is fixedly connected to the cartridge; the inner grinding head is connected to a top cover through a connecting rod; the connecting rod extends through the mounting sleeve; at least one first connecting plate is provided between the mounting sleeve and the cartridge; two ends of the first connecting plate are respectively connected to an outer wall of the mounting sleeve and an inner wall of the cartridge; and the connecting rod is connected to the inner grinding head.

### TECHNICAL FIELD

The present utility model relates to the technical field of grinders, and in particular to a hand-held grinder.

### BACKGROUND TECHNOLOGY

With social progress and development, an increasing number of households are incorporating grinders into their kitchenware to grind seasonings such as Sichuan pepper, pepper and salt, to enrich the taste of food. For most grinders in the prior art, a gear is provided at the bottom of the grinder and adjusted by placing the grinder upside down. In this way, the operation is inconvenient, and the adjustment is cumbersome for the limited bottom space.

### Content of the Utility Model

An objective of the present application is to provide a hand-held grinder. The present application can adjust the grind fineness conveniently.

Technical solutions of the present application are as follows: A hand-held grinder includes a cartridge with an inner cavity, where an adjusting ring is provided on the cartridge; the adjusting ring is sleeved on the cartridge; the adjusting ring is threadedly connected to the cartridge; a mounting sleeve and a grinding assembly are provided in the cartridge; the grinding assembly includes an outer grinding head and an inner grinding head; the outer grinding head is fixedly connected to the cartridge; the inner grinding head is connected to a top cover through a connecting rod; the connecting rod extends through the mounting sleeve; at least one first connecting plate is provided between the mounting sleeve and the cartridge; two ends of the first connecting plate are respectively connected to an outer wall of the mounting sleeve and an inner wall of the cartridge; the connecting rod is connected to the inner grinding head; and the adjusting ring is configured to drive the connecting rod to move up, thereby adjusting a height difference between the outer grinding head and the inner grinding head.

Compared with the prior art, the present application has the following advantages: With the design of the adjusting ring, the present application can adjust the height difference between the outer grinding head and the inner grinding head by rotating the adjusting ring, thereby adjusting the grind fineness, and achieving convenient and smooth operation.

In some embodiments of the present application, the top cover is provided at a top of the cartridge; the top cover can rotate relative to the cartridge; the adjusting ring is located between the cartridge and the top cover; and the inner grinding head is connected to the top cover through the connecting rod.

In some embodiments of the present application, a positioning groove is formed in an inner wall of the adjusting ring; the positioning groove is arranged around a center of the adjusting ring in an array; and a positioning piece cooperating with the positioning groove is provided on an outer wall of the cartridge.

In some embodiments of the present application, a locating ring is provided at a center of the adjusting ring; at least one second connecting plate is provided between the locating ring and the cartridge; two ends of the second connecting plate are respectively connected to an outer wall of the locating ring and an inner wall of the adjusting ring; and the connecting rod extends through the locating ring.

Further, a first mounting groove is formed in the locating ring; a first bearing is provided on the first mounting groove; an inner end and an outer end of the first bearing are respectively connected to the connecting rod and the locating ring; a convex ring is provided on the connecting rod; and the convex ring is configured to block the first bearing.

Further, each of an upper end and a lower end of the mounting sleeve is provided with a second mounting groove; a second bearing is provided on the second mounting groove; an inner end and an outer end of the second bearing are respectively connected to the connecting rod and the mounting sleeve; and an elastic member is provided between the second bearing and the inner grinding head.

In some embodiments of the present application, a polygonal hole is formed in the top cover; and a top end of the connecting rod cooperates with the polygonal hole and extends through the polygonal hole.

Further, a locating hole is formed under the polygonal hole; a part of the connecting rod cooperates with the locating hole and extends through the locating hole; a locating column is provided on the top cover; and the polygonal hole is formed on the locating column and allows the locating column to vertically penetrate.

Further, the top cover includes a bottom plug and a grip sleeve with an inner cavity; the bottom plug is provided at a bottom of the grip sleeve; the bottom plug is threadedly connected to the grip sleeve; the locating column is provided on the bottom plug; an outwardly protruding arcuate surface or hemispherical surface is provided on the bottom plug; and a blocking surface cooperating with the arcuate surface or hemispherical surface is provided on the adjusting ring.

In some embodiments of the present application, a locating seat and a fixing seat are provided at a bottom of the cartridge; the locating seat is fixedly connected to the cartridge; the fixing seat is threadedly connected to the cartridge; and a top surface of the outer grinding head is attached to the locating seat, and a bottom surface of the outer grinding head is attached to the fixing seat.

A hand-held grinder includes a cartridge with an inner cavity, where a mounting sleeve and a grinding assembly are provided in the cartridge; the grinding assembly includes an outer grinding head and an inner grinding head; the outer grinding head is fixedly connected to the cartridge; a connecting rod extends through the mounting sleeve; at least one first connecting plate is provided between the mounting sleeve and the cartridge; two ends of the first connecting plate are respectively connected to an outer wall of the mounting sleeve and an inner wall of the cartridge; the connecting rod is connected to the inner grinding head; a locating seat and a fixing seat are provided at a bottom of the cartridge; the locating seat is fixedly connected to the cartridge; the fixing seat is threadedly connected to the cartridge; and a top surface of the outer grinding head is attached to the locating seat, and a bottom surface of the outer grinding head is attached to the fixing seat.

In some embodiments of the present application, an adjusting ring is provided on the cartridge; the adjusting ring is sleeved on the cartridge; the adjusting ring is threadedly connected to the cartridge; and the adjusting ring is configured to drive the connecting rod to move up, thereby adjusting a height difference between the outer grinding head and the inner grinding head.

In some embodiments of the present application, a top cover is provided at a top of the cartridge; the top cover can rotate relative to the cartridge; the adjusting ring is located between the cartridge and the top cover; and the inner grinding head is connected to the top cover through the connecting rod.

Further, a positioning groove is formed in an inner wall of the adjusting ring; the positioning groove is arranged around a center of the adjusting ring in an array; and a positioning piece cooperating with the positioning groove is provided on an outer wall of the cartridge.

Further, a locating ring is provided at a center of the adjusting ring; at least one second connecting plate is provided between the locating ring and the cartridge; two ends of the second connecting plate are respectively connected to an outer wall of the locating ring and an inner wall of the adjusting ring; and the connecting rod extends through the locating ring.

Further, a first mounting groove is formed in the locating ring; a first bearing is provided on the first mounting groove; an inner end and an outer end of the first bearing are respectively connected to the connecting rod and the locating ring; a convex ring is provided on the connecting rod; and the convex ring is configured to block the first bearing.

Further, each of an upper end and a lower end of the mounting sleeve is provided with a second mounting groove; a second bearing is provided on the second mounting groove; an inner end and an outer end of the second bearing are respectively connected to the connecting rod and the mounting sleeve; and an elastic member is provided between the second bearing and the inner grinding head.

In some embodiments of the present application, a polygonal hole is formed in the top cover; and a top end of the connecting rod cooperates with the polygonal hole and extends through the polygonal hole.

Further, a locating hole is formed under the polygonal hole; a part of the connecting rod cooperates with the locating hole and extends through the locating hole; a locating column is provided on the top cover; and the polygonal hole is formed on the locating column and allows the locating column to vertically penetrate.

Further, the top cover includes a bottom plug and a grip sleeve with an inner cavity; the bottom plug is provided at a bottom of the grip sleeve; the bottom plug is threadedly connected to the grip sleeve; the locating column is provided on the bottom plug; an outwardly protruding arcuate surface or hemispherical surface is provided on the bottom plug; and a blocking surface cooperating with the arcuate surface or hemispherical surface is provided on the adjusting ring.

### DESCRIPTION OF THE DRAWINGS

FIG. 1 is a schematic structural view according to Embodiment 1 of the present utility model;

FIG. 2 is a sectional view according to Embodiment 1 of the present utility model;

FIG. 3 is a schematic structural view of a cartridge according to Embodiment 1 of the present utility model; and

FIG. 4 is a schematic structural view of a locating ring according to Embodiment 1 of the present utility model.

In the figures: 1: cartridge, 2: top cover, 3: mounting sleeve, 4: grinding assembly, 5: outer grinding head, 6: inner grinding head, 7: connecting rod, 8: first connecting plate, 9: adjusting ring, 10: positioning groove, 11: positioning piece, 12: locating ring, 13: second connecting plate, 14: first mounting groove, 15: first bearing, 16: convex ring, 17: second mounting groove, 18: second bearing, 19: elastic member, 20: polygonal hole, 21: locating hole, 22: locating column, 23: bottom plug, 24: grip sleeve, 25: locating seat, 26: fixing seat, 27: hemispherical surface, and 28: blocking surface.

### Specific Implementations

To further describe the technical means adopted by the present utility model to achieve the intended purpose of the present utility model and the effects of the technical means, the specific implementations, structures, features, and effects of the present utility model are described in detail below with reference to the drawings and preferred embodiments.

### Embodiment 1

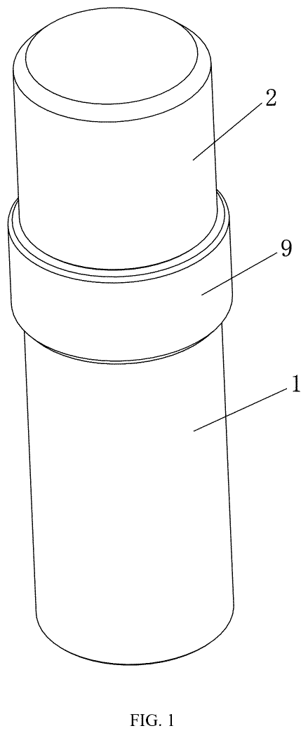

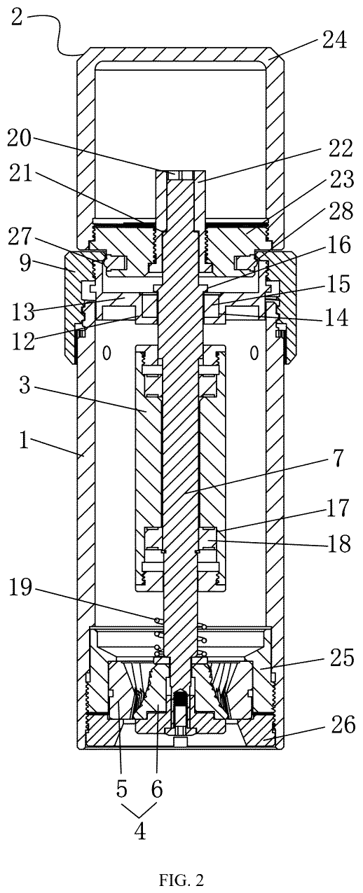

The embodiment provides a hand-held grinder. As shown in FIG. 1 and FIG. 2, the hand-held grinder includes cartridge 1 with an inner cavity. Top cover 2 is provided at a top of the cartridge 1. The top cover 2 can rotate relative to the cartridge 1. Mounting sleeve 3 and grinding assembly 4 are provided in the cartridge 1. The grinding assembly 4 includes outer grinding head 5 and inner grinding head 6. The outer grinding head 5 is fixedly connected to the cartridge 1. The inner grinding head 6 is connected to the top cover 2 through connecting rod 7. The connecting rod 7 extends through the mounting sleeve 3. At least one first connecting plate 8 is provided between the mounting sleeve 3 and the cartridge 1. Two ends of the first connecting plate 8 are respectively connected to an outer wall of the mounting sleeve 3 and an inner wall of the cartridge 1. In the embodiment, there are three first connecting plates 8. The top cover 2 is detachable, such that a material to be ground and crushed is put into the inner cavity of the cartridge 1 conveniently. The inner cavity of the cartridge 1 is configured to accommodate the material to be ground and crushed. The outer grinding head 5 is fixedly connected to the cartridge 1, the inner grinding head 6 is connected to the top cover 2 through the connecting rod 7, and the top cover 2 can rotate relative to the cartridge 1, such that when the top cover 2 is rotated, the top cover 2 drives the connecting rod 7 to rotate, thereby driving the inner grinding head 6 to rotate. The outer grinding head 5 and the inner grinding head 6 rotate relatively to grind and crush the material. Compared with the conventional grinder having a rotatable bottom, with the design of the rotatable top cover 2, the grinder is gripped more suitably to apply a force, and rotated more smoothly. The bottom of the grinder can be made large appropriately to expand an area for grinding and crushing.

In order to adjust grind fineness, adjusting ring 9 is provided between the cartridge 1 and the top cover 2. The adjusting ring 9 is sleeved on the cartridge 1. The adjusting ring 9 is threadedly connected to the cartridge 1. The adjusting ring 9 is configured to drive the connecting rod 7 to move up. With the design of the adjusting ring 9, a height difference between the outer grinding head 5 and the inner grinding head 6 can be adjusted by rotating the adjusting ring 9, thereby adjusting the grind fineness.

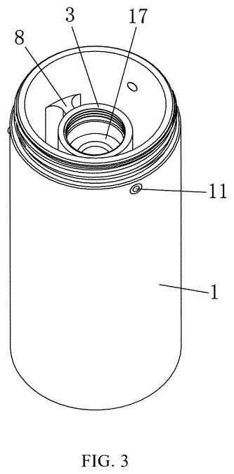

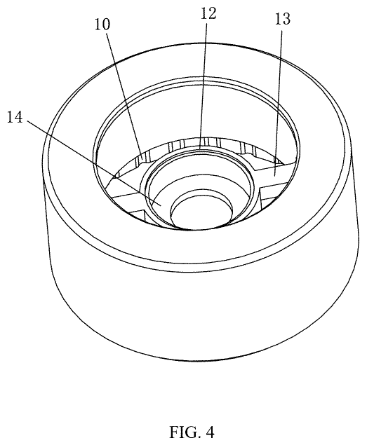

In order to adjust the grind fineness reliably, as shown in FIG. 3 and FIG. 4, positioning groove 10 is formed in an inner wall of the adjusting ring 9. The positioning groove 10 is arranged around a center of the adjusting ring 9 in an array. Positioning piece 11 cooperating with the positioning groove 10 is provided on an outer wall of the cartridge 1. In the embodiment, there are 24 positioning grooves 10, and three positioning pieces 11. The positioning piece 11 is a locating snap. With the cooperative design of the positioning groove 10 and the positioning piece 11, the adjusting ring 9 realizes gear adjustment on the grind fineness, and free rotation of the adjusting ring 9 can be prevented.

In order to mount the connecting rod 7 stably, locating ring 12 is provided at a center of the adjusting ring 9. At least one second connecting plate 13 is provided between the locating ring 12 and the cartridge 1. Two ends of the second connecting plate 13 are respectively connected to an outer wall of the locating ring 12 and an inner wall of the adjusting ring 9. The connecting rod 7 extends through the locating ring 12. The locating ring 12 can function to guide and fix the connecting rod 7, such that the connecting rod 7 rotates more stably.

In order to rotate the connecting rod 7 smoothly, first mounting groove 14 is formed in the locating ring 12. First bearing 15 is provided on the first mounting groove 14. An inner end and an outer end of the first bearing 15 are respectively connected to the connecting rod 7 and the locating ring 12. With the design of the first bearing 15, rotation between the connecting rod 7 and the locating ring 12 can be smoother.

In order to mount the connecting rod 7 reliably, convex ring 16 is provided on the connecting rod 7. The convex ring 16 is attached to a side of the first bearing 15 away from the locating ring 12 to block the first bearing 15. With the design of the convex ring 16, movement of the connecting rod 7 can be limited to prevent the connecting rod 7 from sliding down.

In order to allow the connecting rod 7 to rotate smoothly, each of an upper end and a lower end of the mounting sleeve 3 is provided with second mounting groove 17. Second bearing 18 is provided on the second mounting groove 17. An inner end and an outer end of the second bearing 18 are respectively connected to the connecting rod 7 and the mounting sleeve 3. Elastic member 19 is provided between the second bearing 18 and the inner grinding head 6. In the embodiment, the elastic member 19 is a spring. With the design of the second bearing 18, rotation between the connecting rod 7 and the mounting sleeve 3 is smoother. With the design of the elastic member 19, a downward pressure can be applied to the inner grinding head 6 to ensure reliable mounting of the inner grinding head 6.

In order that the top cover 2 drives the connecting rod 7 to rotate reliably, polygonal hole 20 is formed in the top cover 2. A top end of the connecting rod 7 cooperates with the polygonal hole 20 and extends through the polygonal hole 20. The polygonal hole 20 cooperates with the top end of the connecting rod 7, which can prevent the top end of the connecting rod 7 from slipping, and ensure that the top cover 2 drives the connecting rod 7 to rotate reliably.

In order to facilitate mounting of the connecting rod 7, locating hole 21 is formed under the polygonal hole 20. A part of the connecting rod 7 cooperates with the locating hole 21 and extends through the locating hole 21. Locating column 22 is provided on the top cover 2. The polygonal hole 20 is formed on the locating column 22 and allows the locating column 22 to vertically penetrate. With the design of the locating hole 21, a front end of the connecting rod 7 enters the locating hole 21 before entering the polygonal hole 20. This reduces a moving range of the front end of the connecting rod 7, and facilitates entry of the front end of the connecting rod 7 into the polygonal hole 20. The polygonal hole 20 penetrates through the locating column 22, which facilitates downward ejection of the connecting rod 7 from the polygonal hole 20 to take down the top cover 2.

In order to make the top cover 2 more practical, the top cover 2 includes bottom plug 23 and grip sleeve 24 with an inner cavity. The bottom plug 23 is provided at a bottom of the grip sleeve 24. The bottom plug 23 is threadedly connected to the grip sleeve 24. The locating column 22 is provided on the bottom plug 23. The inner cavity of the grip sleeve 24 may be configured to accommodate a ground product for later use. The bottom plug 23 is threadedly connected to the grip sleeve 24, such that the grip sleeve 24 can be detached conveniently.

In order to enhance connection, outwardly protruding arcuate surface or hemispherical surface 27 is provided on the bottom plug 23. Blocking surface 28 cooperating with the arcuate surface or hemispherical surface 27 is provided on the adjusting ring 9. In the embodiment, the hemispherical surface 27 is provided on the bottom plug 23. The hemispherical surface 27 is formed by a telescopic marble on the bottom plug 23, with a telescoping power provided by a spring. After the bottom plug 23 is mounted, the hemispherical surface 27 is attached to the blocking surface 28, and the blocking surface 28 prevents disengagement of the hemispherical surface 27. In the absence of a force, the bottom plug 23 cannot be disengaged. The bottom plug 23 is pulled forcibly when detached. The hemispherical surface 27 and the adjusting ring 9 deform or the hemispherical surface 27 is stressed to retract inward, such that the bottom plug 23 can be disengaged smoothly.

In order to achieve a reliable grinding gear, locating seat 25 and fixing seat 26 are provided at a bottom of the cartridge 1. The locating seat 25 is fixedly connected to the cartridge 1. The fixing seat 26 is threadedly connected to the cartridge 1. The top surface of the outer grinding head 5 is attached to the locating seat 25, and the bottom surface of the outer grinding head 5 is attached to the fixing seat 26. In the embodiment, the cartridge 1 is sleeved on the locating seat 25 and the fixing seat 26. The locating seat 25 is sleeved on the outer grinding head 5. The locating seat 25 is threadedly connected to the inner wall of the cartridge 1, and fixed by a glue, so as to prevent movement of the locating seat 25. Certainly, the locating seat 25 and the cartridge 1 may also be an integrated structure. For the conventional grinder, after the grinding assembly 4 is detached and cleaned, relative positions of the outer grinding head 5 and the inner grinding head 6 has changed, and the grinding gear is to be readjusted, thereby causing inconvenience in use. With the design of the locating seat 25, the mounting position of the outer grinding head 5 is fixed. The fixing seat 26 is configured to press the outer grinding head 5. A height of the inner grinding head 6 is controlled by the connecting rod 7. The detachment of the inner grinding head 6 does not change the position of the connecting rod 7. After the inner grinding head 6 is remounted, its position does not change. This ensures that the grinding gear does not change, and does not need to be readjusted.

### Embodiment 2

The embodiment provides a hand-held grinder. As shown in FIG. 1 and FIG. 2, the hand-held grinder includes cartridge 1 with an inner cavity. Mounting sleeve 3 and grinding assembly 4 are provided in the cartridge 1. The grinding assembly 4 includes outer grinding head 5 and inner grinding head 6. The outer grinding head 5 is fixedly connected to the cartridge 1. Connecting rod 7 extends through the mounting sleeve 3. At least one first connecting plate 8 is provided between the mounting sleeve 3 and the cartridge 1. Two ends of the first connecting plate 8 are respectively connected to an outer wall of the mounting sleeve 3 and an inner wall of the cartridge 1. The connecting rod 7 is connected to the inner grinding head 6. Locating seat 25 and fixing seat 26 are provided at a bottom of the cartridge 1. The locating seat 25 is fixedly connected to the cartridge 1. The fixing seat 26 is threadedly connected to the cartridge 1. The top surface of the outer grinding head 5 is attached to the locating seat 25, and the bottom surface of the outer grinding head 5 is attached to the fixing seat 26. In the embodiment, the cartridge 1 is sleeved on the locating seat 25 and the fixing seat 26. The locating seat 25 is sleeved on the outer grinding head 5. The locating seat 25 is threadedly connected to the inner wall of the cartridge 1, and fixed by a glue, so as to prevent movement of the locating seat 25. Certainly, the locating seat 25 and the cartridge 1 may also be an integrated structure. For the conventional grinder, after the grinding assembly 4 is detached and cleaned, relative positions of the outer grinding head 5 and the inner grinding head 6 has changed, and the grinding gear is to be readjusted, thereby causing inconvenience in use. With the design of the locating seat 25, the mounting position of the outer grinding head 5 is fixed. The fixing seat 26 is configured to press the outer grinding head 5. A height of the inner grinding head 6 is controlled by the connecting rod 7. The detachment of the inner grinding head 6 does not change the position of the connecting rod 7. After the inner grinding head 6 is remounted, its position does not change. This ensures that the grinding gear does not change, and does not need to be readjusted.

Other technical features are the same as those of Embodiment 1.

The above embodiments are only preferred embodiments of the present utility model, and are not intended to limit the present utility model in any form. Although the present utility model is disclosed through the above preferred embodiments, these preferred embodiments are not intended to limit the present utility model. Any person skilled in the art may make some changes or modifications to the above technical contents without departing from the scope of the technical solutions of the present utility model. However, such changes or modifications should be deemed as equivalent embodiments of the present utility model. Any simple modification, equivalent change and modification made to the above embodiments according to the technical essence of the present utility model without departing from the content in the technical solutions of the present utility model should fall within the scope of the technical solution of the present utility model.

What is claimed is:

1. A hand-held grinder, comprising a cartridge with an inner cavity, wherein an adjusting ring is provided on the cartridge; the adjusting ring is sleeved on the cartridge; the adjusting ring is threadedly connected to the cartridge; a mounting sleeve and a grinding assembly are provided in the cartridge; the grinding assembly comprises an outer grinding head and an inner grinding head; the outer grinding head is fixedly connected to the cartridge; a connecting rod extends through the mounting sleeve; at least one first connecting plate is provided between the mounting sleeve and the cartridge; two ends of the at least one first connecting plate are respectively connected to an outer wall of the mounting sleeve and an inner wall of the cartridge; the connecting rod is connected to the inner grinding head; and the adjusting ring is configured to drive the connecting rod to move up, thereby adjusting a height difference between the outer grinding head and the inner grinding head.

2. The hand-held grinder according to claim 1, wherein a top cover is provided at a top of the cartridge; the top cover is configured to rotate relative to the cartridge; the adjusting ring is located between the cartridge and the top cover; the inner grinding head is connected to the top cover through the connecting rod; a locating seat and a fixing seat are provided at a bottom of the cartridge; the locating seat is fixedly connected to the cartridge; the fixing seat is threadedly connected to the cartridge; and a top surface of the outer grinding head is attached to the locating seat, and a bottom surface of the outer grinding head is attached to the fixing seat.

3. The hand-held grinder according to claim 1, wherein at least one positioning groove is formed in an inner wall of the adjusting ring; the positioning groove is arranged around a center of the adjusting ring in an array; and a positioning piece cooperating with the positioning groove is provided on an outer wall of the cartridge.

4. The hand-held grinder according to claim 1, wherein a locating ring is provided at a center of the adjusting ring; at least one second connecting plate is provided between the locating ring and the cartridge; two ends of the at least one second connecting plate are respectively connected to an outer wall of the locating ring and an inner wall of the adjusting ring; and the connecting rod extends through the locating ring.

5. The hand-held grinder according to claim 4, wherein a first mounting groove is formed in the locating ring; a first bearing is provided on the first mounting groove; an inner end and an outer end of the first bearing are respectively connected to the connecting rod and the locating ring; a convex ring is provided on the connecting rod; and the convex ring is configured to block the first bearing.

6. The hand-held grinder according to claim 5, wherein each of an upper end and a lower end of the mounting sleeve is provided with a second mounting groove; a second bearing is provided on the second mounting groove; an inner end and an outer end of the second bearing are respectively connected to the connecting rod and the mounting sleeve; and an elastic member is provided between the second bearing and the inner grinding head.

7. The hand-held grinder according to claim 2, wherein a polygonal hole is formed in the top cover; and a top end of the connecting rod cooperates with the polygonal hole and extends through the polygonal hole.

8. The hand-held grinder according to claim 7, wherein a locating hole is formed under the polygonal hole; a part of the connecting rod cooperates with the locating hole and extends through the locating hole; a locating column is provided on the top cover; and the polygonal hole is formed on the locating column and allows the locating column to vertically penetrate.

9. The hand-held grinder according to claim 8, wherein the top cover comprises a bottom plug and a grip sleeve, wherein the grip sleeve is provided with an inner cavity; the bottom plug is provided at a bottom of the grip sleeve; the bottom plug is threadedly connected to the grip sleeve; the locating column is provided on the bottom plug; an outwardly protruding arcuate surface or hemispherical surface is provided on the bottom plug; and a blocking surface cooperating with the outwardly protruding arcuate surface or hemispherical surface is provided on the adjusting ring.

10. A hand-held grinder, comprising a cartridge with an inner cavity, wherein a mounting sleeve and a grinding assembly are provided in the cartridge; the grinding assembly comprises an outer grinding head and an inner grinding head; the outer grinding head is fixedly connected to the cartridge; a connecting rod extends through the mounting sleeve; at least one first connecting plate is provided between the mounting sleeve and the cartridge; two ends of the at least one first connecting plate are respectively connected to an outer wall of the mounting sleeve and an inner wall of the cartridge; the connecting rod is connected to the inner grinding head; a locating seat and a fixing seat are provided at a bottom of the cartridge; the locating seat is fixedly connected to the cartridge; the fixing seat is threadedly connected to the cartridge; and a top surface of the outer grinding head is attached to the locating seat, and a bottom surface of the outer grinding head is attached to the fixing seat.
